(19) United States
(12) Patent Application Publication
(10) Pub. No.: US 2005/0275737 A1
(43) Pub. Date: Dec. 15, 2005

(54) System and method for effectively utilizing a live preview mode in an electronic imaging device

(76) Inventor: Brett Anthony Cheng, Vancouver (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/865,415

(22) Filed: Jun. 10, 2004

(51) Int. Cl. H04N 5/222; G06K 9/00

(52) U.S. Cl. 348/333.02; 382/169

(57) ABSTRACT

A system and method for effectively utilizing a live preview mode in an electronic device includes a capture subsystem configured to generate image data that has luminosity characteristics that vary depending upon corresponding exposure settings of the electronic device. A display controller of the electronic device analyzes the image data from the capture subsystem to create a live preview representation of the foregoing exposure characteristics of the image data. In certain embodiments, the live preview representation may include a live preview histogram. The display controller then displays the live preview representation on a display of the electronic device in either a manual live preview mode or an automatic live preview mode. The display controller may be utilized to adjust the exposure settings of the capture subsystem after the live preview representation is analyzed to efficiently optimize the luminosity characteristics of the image data. Finally, the capture subsystem may then store the optimized image data as a final captured image for subsequent use.

### BACKGROUND SECTION

1. Field of Invention

This invention relates generally to electronic imaging systems, and relates more particularly to a system and method for effectively utilizing a live preview mode in an electronic device.

2. Description of the Background Art

Implementing effective methods for capturing electronic image data is a significant consideration for designers and manufacturers of contemporary electronic devices. However, effectively capturing image data with electronic devices may create substantial challenges for system designers. For example, enhanced demands for increased device functionality and performance may require more system operating power and require additional hardware resources. An increase in power or hardware requirements may also result in a corresponding detrimental economic impact due to increased production costs and operational inefficiencies.

Furthermore, enhanced device capability to perform various advanced capture operations may provide additional benefits to a system user, but may also place increased demands on the control and management of various device components. For example, an enhanced electronic device that efficiently captures and displays digital image data may benefit from an efficient implementation because of the large amount and complexity of the digital data involved.

Due to growing demands on system functionalities and substantially increasing data magnitudes, it is apparent that developing new techniques for capturing electronic image data is a matter of concern for related electronic technologies. Therefore, for all the foregoing reasons, developing effective systems for capturing electronic image data remains a significant consideration for designers, manufacturers, and users of contemporary electronic devices.

### SUMMARY

In accordance with the present invention, a system and method are disclosed for effectively utilizing a live preview mode in an electronic device. In certain embodiments, a device user initially enables live preview mode in the electronic device by utilizing any effective means. The foregoing live preview mode may be selected to function in either a manual mode or an automatic mode. The device user also selects an initial exposure setting for a capture subsystem of the electronic device.

A display controller of the electronic device then utilizes a histogram generator to analyze image data provided by the capture subsystem for generating a histogram corresponding to luminosity characteristics of the foregoing image data. The display controller displays the generated histogram and corresponding image data simultaneously on a live preview screen of a display of the electronic device.

In the manual live preview mode, the device user may then analyze the displayed histogram for determining whether to adjust the exposure setting of the capture subsystem. If the device user determines that the exposure setting should be adjusted, then the device user may manually adjust the exposure setting of the capture subsystem by utilizing any effective means.

Alternately, in the automatic live preview mode, a histogram analyzer of the display controller automatically analyzes the generated histogram for certain pre-determined characteristics to generate a histogram analysis. The histogram analyzer then determines whether to adjust the exposure setting of the capture subsystem based upon pre-defined adjustment criteria in light of the foregoing histogram analysis. If the histogram analyzer determines that the exposure setting should be adjusted based upon the pre-defined adjustment criteria, then the display controller may automatically adjust the exposure setting of capture subsystem by utilizing any effective means.

When the luminosity characteristics of the image data are determined to be optimal, then the electronic device may capture, encode, and store the optimized image data as a final captured image in an image memory for subsequent use. The display controller may also display the stored image data and the corresponding final histogram upon the display of the electronic device for viewing by the device user. For at least the foregoing reasons, the present invention therefore provides an improved system and method for effectively utilizing a live preview mode in an electronic device.

### BRIEF DESCRIPTION OF THE DRAWINGS

FIG. 1 is a block diagram for one embodiment of an electronic device, in accordance with the present invention;

FIG. 2 is a block diagram for one embodiment of the capture subsystem of FIG. 1, in accordance with the present invention;

FIG. 3 is a block diagram for one embodiment of the display controller of FIG. 1, in accordance with the present invention;

FIG. 4 is a block diagram for one embodiment of controller registers, in accordance with the present invention;

FIG. 5 is a block diagram for one embodiment of the display of FIG. 1, in accordance with the present invention;

FIG. 6 is one embodiment of a live preview representation, in accordance with the present invention;

FIG. 7 is one embodiment of live preview screen, in accordance with the present invention;

FIG. 8 is a flowchart of method steps for utilizing a manual live preview mode, in accordance with one embodiment of the present invention; and

FIG. 9 is a flowchart of method steps for utilizing an automatic live preview mode, in accordance with one embodiment of the present invention.

### DETAILED DESCRIPTION

The present invention relates to an improvement in electronic imaging systems. The following description is presented to enable one of ordinary skill in the art to make and use the invention, and is provided in the context of a patent application and its requirements. Various modifications to the embodiments disclosed herein will be apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for effectively utilizing a live preview mode in an electronic device, and includes a capture subsystem configured to generate image data that has luminosity characteristics that vary depending upon corresponding exposure settings of the electronic device. A display controller of the electronic device analyzes the image data from the capture subsystem to create a live preview representation of the foregoing exposure characteristics of the image data. In certain embodiments, the live preview representation may include a live preview histogram.

The display controller then displays the live preview representation on a display of the electronic device in either a manual live preview mode or an automatic live preview mode. The display controller may be utilized to adjust the exposure settings of the capture subsystem after the live preview representation is analyzed to efficiently optimize the luminosity characteristics of the image data. Finally, the capture subsystem may then store the optimized image data as a final captured image for subsequent use.

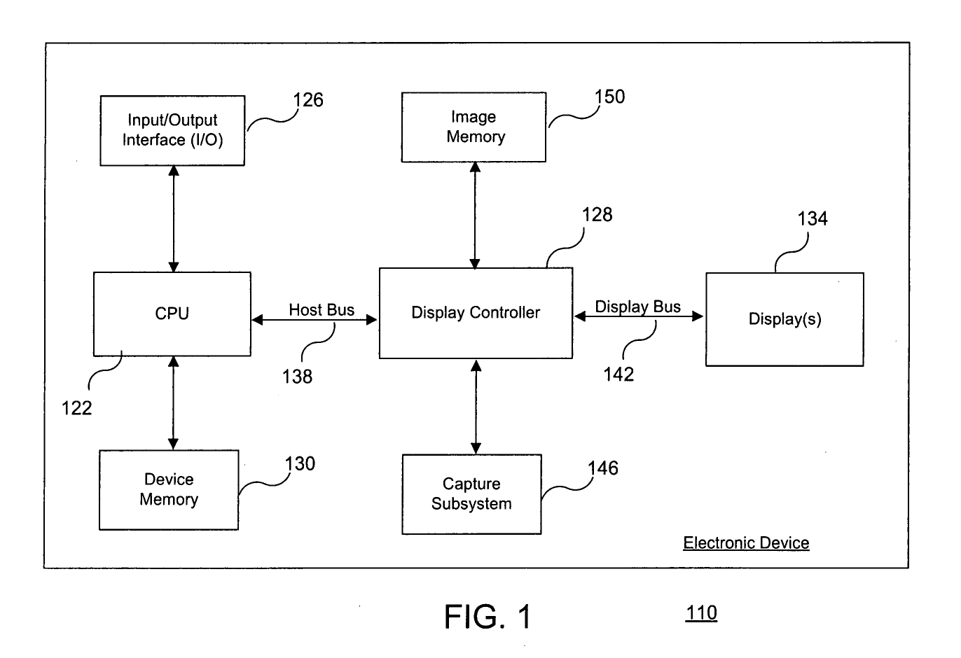

Referring now to FIG. 1, a block diagram for one embodiment of an electronic device 110 is shown, according to the present invention. The FIG. 1 embodiment includes, but is not limited to, a central processing unit (CPU) 122, an input/output interface (I/O) 126, a display controller 128, a device memory 130, one or more display(s) 134, a capture subsystem 146, and an image memory 150. In alternate embodiments, electronic device 110 may include elements or functionalities in addition to, or instead of, certain of the elements or functionalities discussed in conjunction with the FIG. 1 embodiment.

In the FIG. 1 embodiment, CPU 122 may be implemented to include any appropriate and effective processor device or microprocessor for controlling and coordinating the operation of electronic device 110 in response to various software program instructions. In the FIG. 1 embodiment, device memory 130 may comprise any desired storage-device configurations, including, but not limited to, random access memory (RAM), read-only memory (ROM), and storage devices such as removable memory or hard disk drives. In the FIG. 1 embodiment, device memory 130 may include, but is not limited to, a device application of program instructions that are executed by CPU 122 to perform various functions and operations for electronic device 110. The particular nature and functionality of the device application typically varies depending upon factors such as the type and specific use of the corresponding electronic device 110.

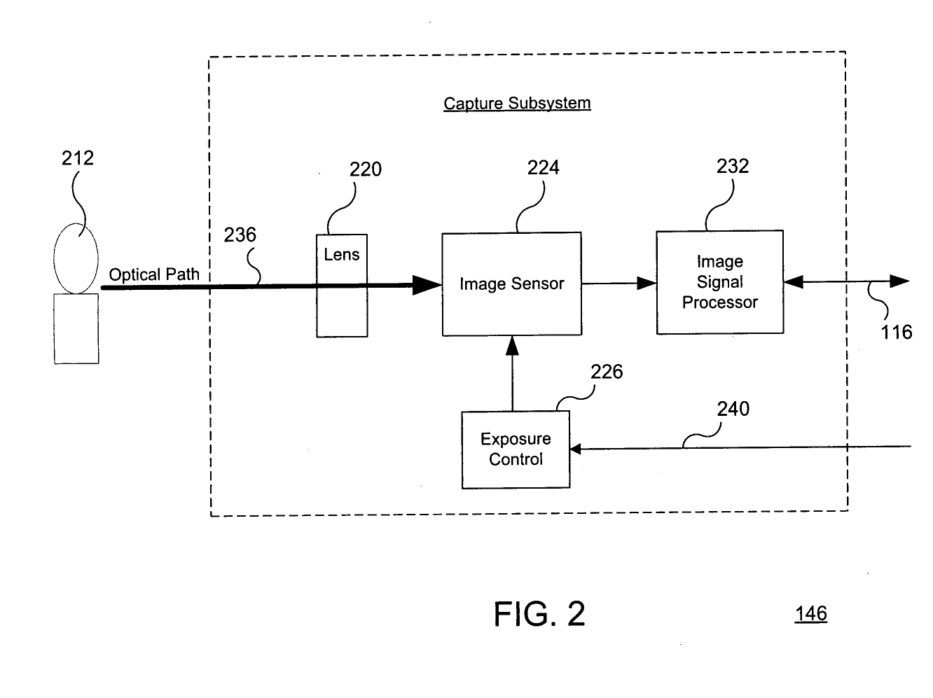

In the FIG. 1 embodiment, display controller 128 may receive image data from capture subsystem 146 in accordance with the present invention. The implementation and operation of capture subsystem 146 with display controller 128 is further discussed below in conjunction with FIG. 2. In the FIG. 1 embodiment, input/output interface (I/O) 126 may include one or more interfaces to receive and/or transmit any required types of information to or from electronic device 110. Input/output interface 126 may enable various external electronic devices to communicate with electronic device 110. In addition, input/output interface 126 may include one or more means for allowing a device user to communicate with electronic device 110.

In the FIG. 1 embodiment, electronic device 110 may advantageously utilize display controller 128 for efficiently managing various operations and functionalities relating to display(s) 134. The implementation and functionality of display controller 128 is further discussed below in conjunction with FIGS. 2-4 and 6-9. Electronic device 110 may utilize image memory 150 for storing appropriate image data captured by capture subsystem 146. In the FIG. 1 embodiment, electronic device 110 may be implemented as any desired type of electronic device or system. For example, in certain embodiments, electronic device 110 may alternately be implemented as a cellular telephone, a digital camera, a personal digital assistant device, an electronic imaging device, or a computer device. Various embodiments for the operation and utilization of electronic device 110 are further discussed below in conjunction with FIGS. 2-9.

Referring now to FIG. 2, a block diagram for one embodiment of the FIG. 1 capture subsystem 146 is shown, according to the present invention. The FIG. 2 embodiment includes, but is not limited to, a lens 220, an image sensor 224, an exposure control 226, and an image signal processor 232. In alternate embodiments, capture subsystem 146 may include elements or functionalities in addition to, or instead of, certain of the elements or functionalities discussed in conjunction with the FIG. 2 embodiment.

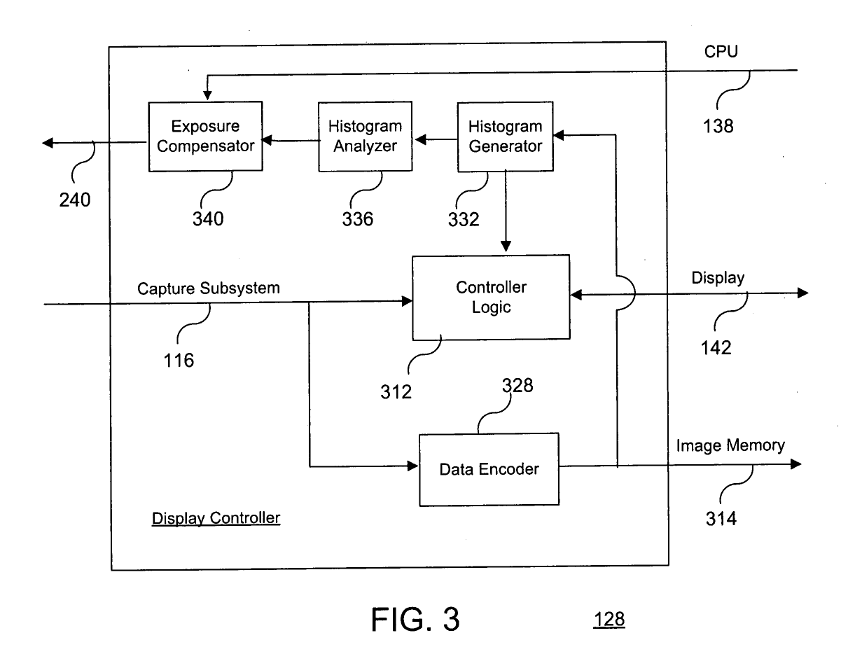

In the FIG. 2 embodiment, capture subsystem 146 may capture image data corresponding to photographic target 212 by detecting reflected light impacting image sensor 224 along optical path 236. Image sensor 224 may responsively generate a set of image data representing the photographic target 212. The image data may be processed by image signal processor 232 and provided to display controller 128 (FIG. 1) via path 116. In certain embodiments, image signal processor 232 may be implemented as part of display controller 128 (FIG. 1). In the FIG. 2 embodiment, capture subsystem 146 may utilize exposure control 226 to control exposure settings for image sensor 224 in response to exposure control signals from display controller 128 via path 240. Various techniques for controlling capture subsystem 146 are further discussed below in conjunction with FIGS. 3-4 and 6-9.

Referring now to FIG. 3, a block diagram for one embodiment of the FIG. 1 display controller 128 is shown, according to the present invention. The FIG. 3 embodiment includes, but is not limited to, controller logic 312, a data encoder 328, a histogram generator 332, a histogram analyzer 336, and an exposure compensator 340. In alternate embodiments, display controller 128 may include elements or functionalities in addition to, or instead of, certain of the elements or functionalities discussed in conjunction with the FIG. 3 embodiment.

In the FIG. 3 embodiment, display controller 128 may be implemented as an integrated circuit device that manages various types of received image data and related functionalities. Display controller 128 may provide the received image data to display 134 of electronic device 110 in an appropriate and efficient manner for displaying to a device user. In the FIG. 3 embodiment, controller logic 312 manages the overall operation of display controller 128. In certain embodiments, controller logic 312 may include, but is not limited to, an image creation module that manages forming image pixels for display.

In the FIG. 3 embodiment, data encoder 328 may receive image data from capture subsystem 146 via path 116, and may responsively encode and store the received image data into image memory 150 (FIG. 1) via path 314. In addition, controller logic 312 may receive the image data from capture subsystem 146 via path 116, and may responsively provide the received image data to display 134 (FIG. 1) of electronic device 110 for viewing by a device user.

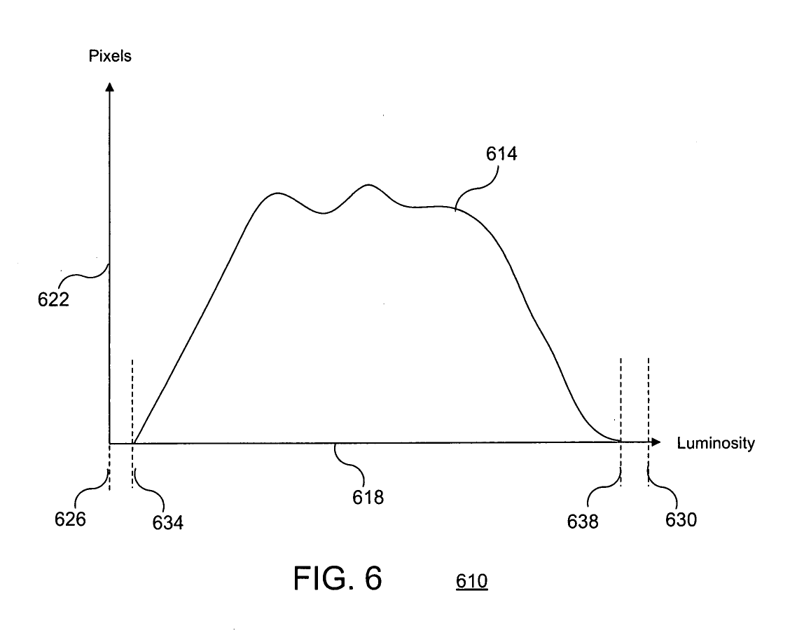

In the FIG. 3 embodiment, data encoder 328 may also provide the image data to a histogram generator 332 that analyzes specific image characteristics of the image data to generate a corresponding histogram or other representation that controller logic 312 may then provide to display 134 for viewing by the device user during a live preview procedure. Certain properties and characteristics of the foregoing histogram are further discussed below in conjunction with FIGS. 6-9.

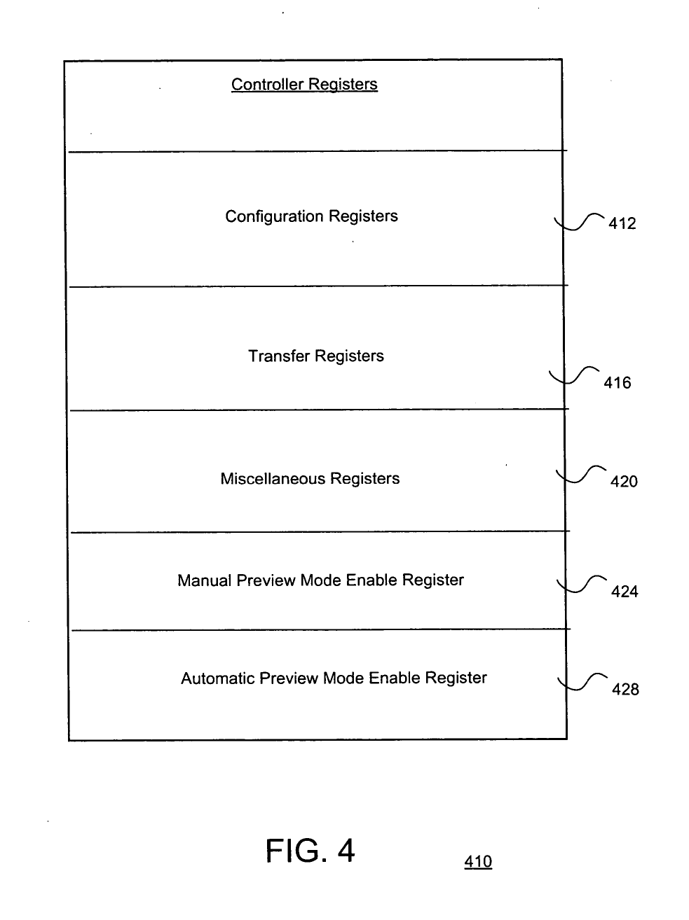

In a manual live preview mode, the device user may view a displayed histogram, and may then utilize appropriate manual controls of input/output interface 126 (FIG. 1) to control exposure compensator 340 via path 138. Alternately, in an automatic live preview mode, histogram analyzer 336 may perform an automatic histogram analysis procedure upon the histogram generated by histogram generator 332. Histogram analyzer 336 may then provide appropriate control signals to automatically adjust exposure compensator 340. In the FIG. 3 embodiment, exposure compensator 340 provides exposure compensation signals to exposure control 226 of capture subsystem 146 via path 240. Certain embodiments for the implementation and utilization of display controller 128 are further discussed below in conjunction with FIGS. 4 and 6-9.

Referring now to FIG. 4, a block diagram for one embodiment of controller registers 410 is shown, in accordance with the present invention. In the FIG. 4 embodiment, controller registers 410 include, but are not limited to, configuration registers 412, transfer registers 416, miscellaneous registers 420, a manual mode preview enable register 424, and an automatic mode preview enable register 428. In alternate embodiments, controller registers 410 may include elements and functionalities in addition to, or instead of, certain of the elements and functionalities discussed in conjunction with the FIG. 4 embodiment. Furthermore, in certain embodiments, controller registers 410 may be implemented as part of display controller 128.

In the FIG. 4 embodiment, CPU 122 (FIG. 1) or other appropriate entities may advantageously write information into controller registers 220 to specify various types of operational parameters and other relevant information for use by controller logic 312 of display controller 128. In the FIG. 4 embodiment, controller registers 410 may utilize configuration registers 412 for storing various types of information relating to the configuration of display controller 128 and/or display 134 of electronic device 110. For example, configuration registers 410 may specify a display type, a display size, a display frame rate, and various display timing parameters for display 134 (FIG. 1). In the FIG. 4 embodiment, controller registers 410 may utilize transfer registers 416 for storing various types of information relating to transfer operations for providing image data to display 134 of electronic device 110.

In the FIG. 4 embodiment, controller registers 410 may utilize miscellaneous registers 420 for effectively storing any desired type of information or data for use by display controller 128. In the FIG. 4 embodiment, a device user or other appropriate entity may program manual preview mode enable register 424 to enable a manual live preview mode in electronic device 110. For example, the device user may utilize input/output interface 126 (FIG. 1) to enable the foregoing manual live preview mode. In the FIG. 4 embodiment, a device user or other appropriate entity may also similarly program automatic preview mode enable register 428 to enable an automatic live preview mode in electronic device 110. For example, the device user may utilize input/output interface 126 (FIG. 1) to enable the foregoing automatic live preview mode.

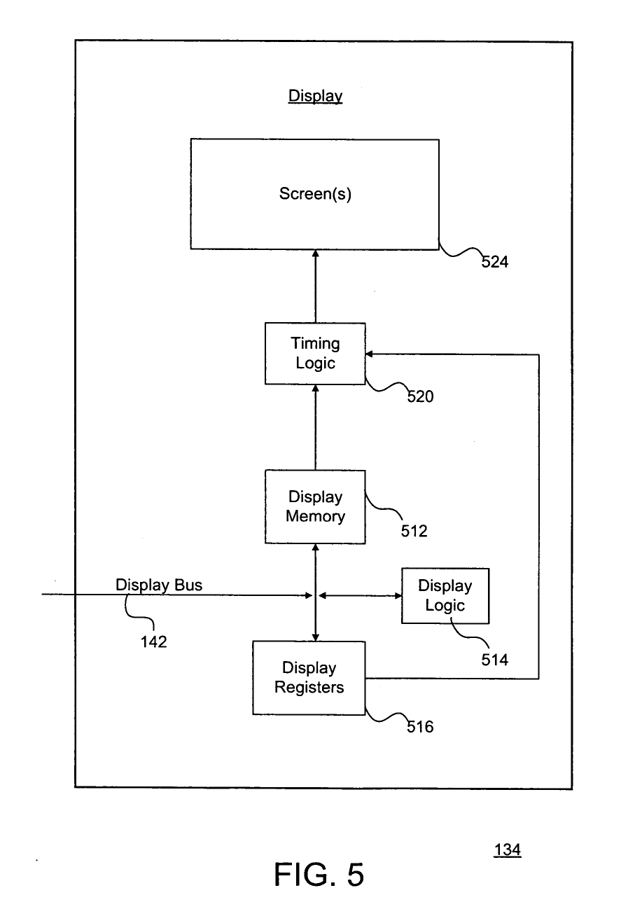

Referring now to FIG. 5, a block diagram for one embodiment of the FIG. 1 display 134 is shown, in accordance with the present invention. In the FIG. 5 embodiment, display 134 includes, but is not limited to, a display memory 512, display logic 514, display registers 516, timing logic 520, and one or more screen(s) 524. In alternate embodiments, display 134 may include elements and functionalities in addition to, or instead of, certain of the elements and functionalities discussed in conjunction with the FIG. 5 embodiment.

In the FIG. 5 embodiment, display 134 is implemented as a random-access-memory based liquid-crystal display panel (RAM-based LCD panel). However, in alternate embodiments, display 134 may be implemented by utilizing any type of appropriate display technologies or configurations. In the FIG. 5 embodiment, display controller 128 (FIG. 3) provides various types of display information to display registers 516 via display bus 142. Display registers 516 may then utilize the received display information for effectively controlling timing logic 520. In the FIG. 5 embodiment, display logic 514 manages and coordinates data transfer and display functions for display 134.

In the FIG. 5 embodiment, display controller 128 (FIG. 3) provides image data from video memory 216 (FIG. 2) to display memory 512 via display bus 142. In the FIG. 5 embodiment, display memory 512 is typically implemented as random-access memory (RAM). However, in various other embodiments, any effective types or configurations of memory devices may be utilized to implement display memory 512. In the FIG. 5 embodiment, display memory 512 then advantageously provides the image data received from display controller 128 to one or more screens 524 via timing logic 520 for viewing by a device user of electronic device 110.

Referring now to FIG. 6, a diagram for one embodiment of a live preview representation 610 is shown, in accordance with the present invention. In the FIG. 6 embodiment, live preview representation 610 is shown for purposes of illustration, and in alternate embodiments, live preview representation 610 may include elements and characteristics in addition to, or instead of, certain of the elements and characteristics discussed in conjunction with the FIG. 6 embodiment.

In the FIG. 6 embodiment, live preview representation 610 may advantageously be displayed by display controller 129 (FIG. 3) upon display 134 (FIG. 1) during a live preview mode, as discussed above in conjunction with FIG. 3. In the FIG. 6 embodiment, live preview representation 610 includes a vertical axis 622 corresponding to pixel quantities from a given captured image from capture subsystem 146. In addition, live preview representation 610 also includes a horizontal axis 618 that corresponds to luminosity values of the pixels from the same captured image. In the FIG. 6 embodiment, horizontal axis 618 includes a minimum luminosity value 626 and a maximum luminosity value 630.

In the FIG. 6 embodiment, live preview representation 610 also includes a histogram 614 that represents the image data received from capture subsystem 146. The foregoing histogram 614 includes one or more brightest pixels 638 and one or more darkest pixels 634 from the image data. In accordance with the present invention, histogram 614 may be utilized to accurately adjust exposure settings of capture subsystem 146 during the live preview mode before efficiently storing a final version of a particular image only after a desired exposure setting has been attained. For example, in certain embodiments, electronic device 110 may adjust the position of brightest pixel(s) 638 with reference to maximum luminosity value 630. In addition, in certain embodiments, electronic device 110 may also similarly adjust the position of darkest pixel(s) 634 with reference to minimum luminosity value 626.

In certain embodiments of the present invention, in order to maximize the signal-to-noise ratio of a given captured image, a highlight-biased exposure technique may be implemented by utilizing histogram 614 in either a manual live preview mode or an automatic live preview mode. With the highlight-biased exposure technique, the exposure setting of capture subsystem 146 may be adjusted to advantageously position histogram 614 as close as possible to maximum luminosity value 630 without clipping brightest pixel(s) 638. In certain embodiments, image sensor 224 (FIG. 2) exhibits linear response characteristics. The foregoing highlight-based exposure technique takes full advantage of the entire luminosity range by biasing exposure to the right side of representation 610, thereby leaving maximum room for pixels with low luminosity levels above signal noise levels.

The live view preview mode of the present invention therefore enables a device user with means for quickly evaluating and adjusting various image characteristics before capturing and storing a final version of a given image. In the FIG. 6 embodiment, histogram 614 is discussed in the context of representing luminance characteristics in order to evaluate exposure settings. However, in alternate embodiments of the present invention, the foregoing techniques may be applied to evaluating and adjusting other parameters and characteristics of any appropriate type of data or information.

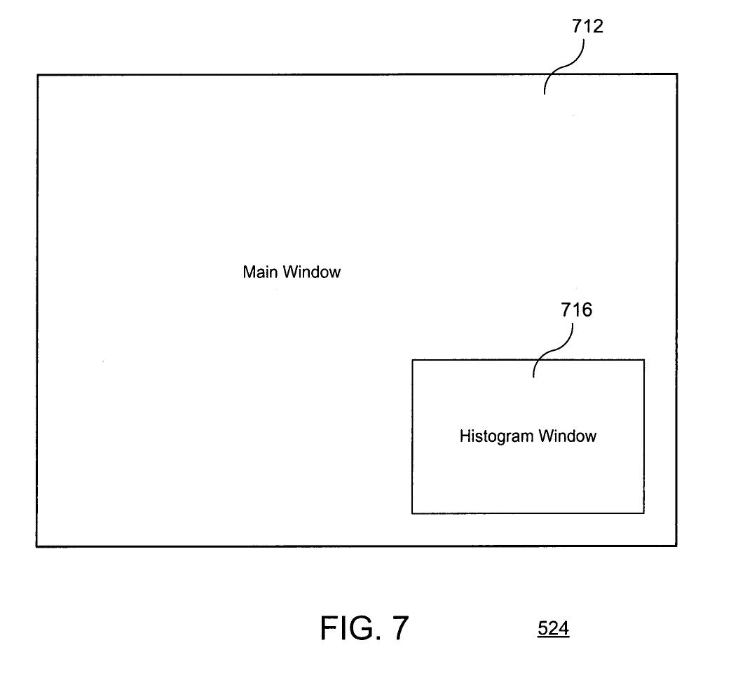

In addition, in the FIG. 6 embodiment, live preview representation 610 utilizes histogram 614 to provide a visual representation to a device user. However, in certain other embodiments, live preview representation 610 may alternately utilize various other appropriate means and techniques for representing desired data characteristics. In addition, live preview representation 610 may be implemented to display a histogram 614 that collectively or individually displays luminosity values of individual Red, Green, and Blue channels of the image data. The utilization of live preview representation 610 is further discussed below in conjunction with FIGS. 7-9.

Referring now to FIG. 7, a diagram for one embodiment of a live preview screen 524 of display 134 (FIG. 1) is shown, in accordance with the present invention. In alternate embodiments, live preview screen 524 may include elements and functionalities in addition to, or instead of, certain of the elements and functionalities discussed in conjunction with the FIG. 7 embodiment.

In the FIG. 7 embodiment, live preview screen 524 includes a main window 712 for displaying a live preview of image data corresponding to a selected photographic target 212 (FIG. 2). In addition, in the FIG. 7 embodiment, live preview screen 524 includes a histogram window 716 for simultaneously displaying a live preview representation 610 (FIG. 6). In the FIG. 7 embodiment, histogram window 716 may be implemented as an overlay of main window 712.

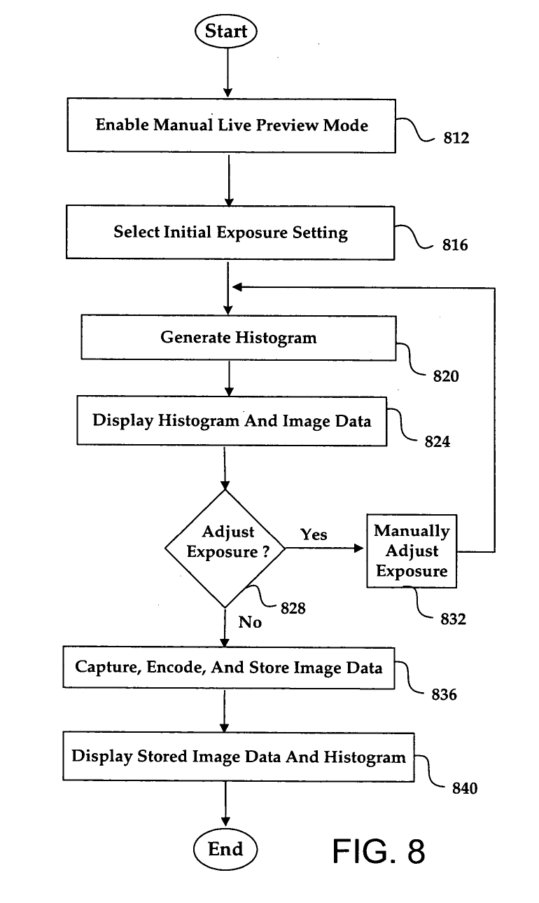

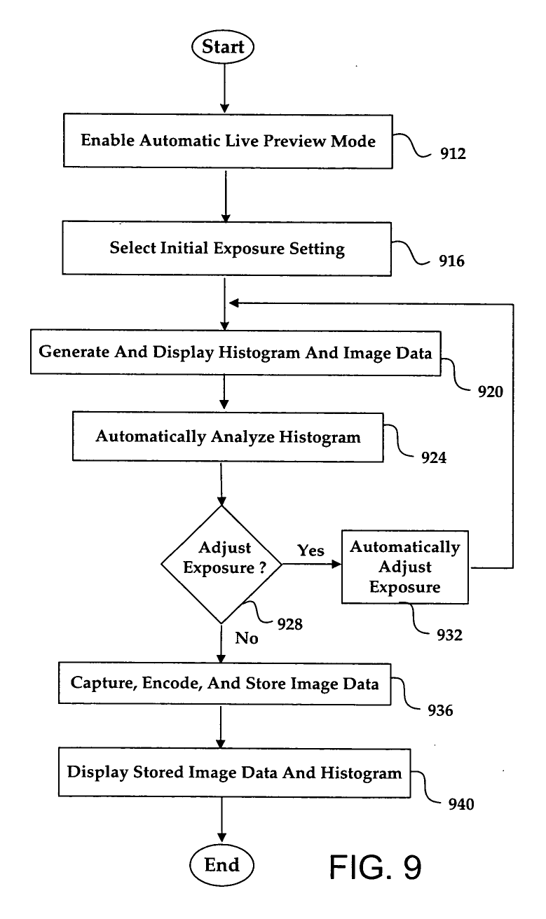

In certain other embodiments, histogram window 716 may alternately be implemented to include a semi-transparent version of live preview representation 610 that is superimposed over information in main window 712. In other embodiments, histogram window 716 may also be displayed on a separate physical display for viewing by a device user of electronic device 110. Several embodiments for implementing live preview modes in electronic device 110 are further discussed below in conjunction with FIGS. 8-9.

Referring now to FIG. 8, a flowchart of method steps for utilizing a manual live preview mode is shown, in accordance with one embodiment of the present invention. The FIG. 8 flowchart is presented for purposes of illustration, and in alternate embodiments, the present invention may utilize steps and sequences in addition to, or instead of, certain of the steps and sequences discussed in conjunction with the FIG. 8 embodiment.

In the FIG. 8 embodiment, in step 812, a device user or other appropriate entity enables a manual live preview mode in electronic device 110 by utilizing any effective means. For example, in certain embodiments, the manual live preview mode may be enabled by programming a manual preview mode enable register 424 in controller registers 410. In step 816, the device user or other appropriate entity selects an initial exposure setting for a capture subsystem 146 of electronic device 110. Then, in step 820, a histogram generator 332 of a display controller 128 analyzes captured image data from the capture subsystem 146 to generate a histogram 614 corresponding to luminosity characteristics of the foregoing captured image data.

In step 824, display controller 128 simultaneously displays the generated histogram 614 and the captured image data on a live preview screen 524 of electronic device 110. Next, in step 828, the device user or other appropriate entity may determine whether to adjust the exposure settings of capture subsystem 146 by analyzing histogram 614 on live preview screen 524. If the device user or other appropriate entity determines that the exposure settings of capture subsystem 146 should be adjusted, then in step 832, the device user or other appropriate entity may manually adjust the exposure settings of capture subsystem 146 by utilizing any effective means. The FIG. 8 process may then return to step 820 to generate and display a new histogram 614 based upon the current exposure settings of capture subsystem 146.

However, in step 828, if the device user or other appropriate entity determines that the exposure settings of capture subsystem 146 need not be adjusted, then in step 836, electronic device 110 may capture, encode, and store final image data into image memory 150 (FIG. 1). In the FIG. 8 embodiment, electronic device 110 typically captures, encodes, and stores the final image data in response to an image capture instruction received from the device user or other appropriate entity. Finally, in step 840, display controller 128 may display the stored image data and the corresponding histogram 614 upon display 134 of electronic device 110. The FIG. 8 process may then terminate.

Conventional imaging devices typically only allow analysis of the image histogram after an image is captured and stored in memory. If any image characteristics need adjustment based on analysis of the histogram, then device settings must first be modified and then a second image must be captured and stored. In contrast, the present invention efficiently utilizes the live preview mode to analyze histogram 614 before capturing and storing only the final image data. Therefore, in accordance with the present invention, only one final version of the image data need be captured by electronic device 110. For at least the foregoing reasons, the present invention therefore provides an improved system and method for effectively utilizing a live preview mode in an electronic device.

Referring now to FIG. 9, a flowchart of method steps for utilizing an automatic live preview mode is shown, in accordance with one embodiment of the present invention. The FIG. 9 flowchart is presented for purposes of illustration, and in alternate embodiments, the present invention may utilize steps and sequences in addition to, or instead of, certain of the steps and sequences discussed in conjunction with the FIG. 9 embodiment.

In the FIG. 9 embodiment, in step 912, a device user or other appropriate entity enables an automatic live preview mode in electronic device 110 by utilizing any effective means. For example, in certain embodiments, the automatic live preview mode may be enabled by programming an automatic preview mode enable register 428 in controller registers 410. In step 916, the device user or other appropriate entity selects an initial exposure setting for a capture subsystem 146 of electronic device 110. Then, in step 920, a histogram generator 332 of a display controller 128 analyzes captured image data from the capture subsystem 146 to generate a histogram 614 corresponding to luminosity characteristics of the foregoing captured image data. Also in step 920, display controller 128 simultaneously displays the generated histogram 614 and the captured image data on a live preview screen 524 of electronic device 110.

Next, in step 924, a histogram analyzer 336 of the display controller 128 automatically analyzes the generated histogram 614 for certain pre-determined characteristics to generate a histogram analysis. Then, in step 928, histogram analyzer 336 determines whether to adjust the exposure settings of capture subsystem 146 based upon certain pre-defined adjustment criteria in light of the foregoing histogram analysis. If histogram analyzer 336 determines that the exposure settings of capture subsystem 146 should be adjusted based upon the pre-defined adjustment criteria, then in step 932, an exposure compensator 340 may automatically adjust the exposure settings of capture subsystem 146 by utilizing any effective means. The FIG. 9 process may then return to step 920 to generate and display a new histogram 614 based upon the current exposure settings of capture subsystem 146.

However, in step 928, if histogram analyzer 336 determines that the exposure settings of capture subsystem 146 need not be adjusted, then in step 936, electronic device 110 may capture, encode, and store final image data into image memory 150 (FIG. 1). Finally, in step 940, display controller 128 may display the stored image data and the corresponding histogram 614 upon display 134 of electronic device 110. The FIG. 9 process may then terminate.

In certain embodiments of the present invention, the foregoing automatic live preview mode may readily function without presenting histogram 614 for viewing by a device user. For example, in step 920 of the FIG. 9 embodiment, although histogram 614 would still be generated by histogram generator 332, histogram 614 need not be displayed on display 134 for viewing by a device user. Similarly, step 940 of the FIG. 9 embodiment for displaying the stored final image and corresponding histogram 614 may likewise be omitted. For at least the foregoing reasons, the present invention therefore provides an improved system and method for effectively utilizing a live preview mode in an electronic device.

The invention has been explained above with reference to certain preferred embodiments. Other embodiments will be apparent to those skilled in the art in light of this disclosure. For example, the present invention may be implemented using certain configurations and techniques other than those described in the embodiments above. Additionally, the present invention may effectively be used in conjunction with systems other than those described above as the preferred embodiments. Therefore, these and other variations upon the foregoing embodiments are intended to be covered by the present invention, which is limited only by the appended claims.

1. A system for capturing electronic information with an electronic device, comprising:
a capture subsystem configured to generate image data that has image characteristics that vary depending upon one or more capture settings; and
a display controller coupled to said capture subsystem for creating a live preview representation of said image characteristics, said display controller adjusting said one or more capture settings after said representation is analyzed during a live preview mode, said capture subsystem then storing said image data as a final captured image.

2. The system of claim 1 wherein said one or more capture settings include an exposure setting for controlling luminosity characteristics of said image data provided by said capture subsystem.

3. The system of claim 2 wherein said live preview representation includes a histogram of luminosity characteristics of said image data, said histogram displaying luminosity levels for pixels of said image data ranging from one or more darkest pixels to one or more brightest pixels.

4. The system of claim 3 wherein a device user utilizes a user interface for manually adjusting said exposure setting after analyzing said histogram to thereby optimize said luminosity characteristics of said final captured image.

5. The system of claim 3 wherein a histogram analyzer of said display controller automatically adjusts said exposure setting after analyzing said histogram to thereby optimize said luminosity characteristics of said final captured image according to one or more pre-defined criteria.

6. The system of claim 2 wherein said capture subsystem includes an image sensor for initially generating said image data, an image signal processor for processing said image data, and an exposure control module that provides said exposure setting to said image sensor to vary said luminosity characteristics of said image data.

7. The system of claim 3 wherein said display controller includes controller logic that provides said image data and said histogram to a display of said electronic device, said display controller also including a histogram generator for analyzing said image data to generate said histogram, said display controller further including an exposure compensator for generating an exposure compensation signal that is provided to said capture subsystem.

8. The system of claim 7 wherein said display controller supports a manual live preview mode during which a device user manually controls said exposure compensator after analyzing said histogram on said display.

9. The system of claim 7 said display controller supports an automatic live preview mode during which a histogram analyzer automatically controls said exposure compensator after analyzing said histogram according to one or more pre-defined analysis criteria.

10. The system of claim 1 wherein a device user selects a manual live preview mode for said electronic device by programming a manual preview mode enable register, said device user alternately selecting an automatic live preview mode for said electronic device by programming an automatic preview mode enable register.

11. The system of claim 3 wherein said histogram includes a vertical axis corresponding to pixel quantities of said pixels from said image data, said histogram also including a horizontal axis that corresponds to said luminosity characteristics of said pixels, said horizontal axis having a minimum luminosity value and a maximum luminosity value.

12. The system of claim 11 wherein said display controller is capable of adjusting an upper position of said one or more brightest pixels with reference to said maximum luminosity value, said display controller also being capable of separately adjusting a lower position of said one or more darkest pixels with reference to said minimum luminosity value.

13. The system of claim 11 wherein said display controller utilizes a highlight-biased exposure technique to maximize a signal-to-noise ratio of said final captured image, said display controller adjusting said exposure setting of said capture subsystem to position said histogram as close as possible to said maximum luminosity value without clipping said one or more brightest pixels.

14. The system of claim 3 wherein said histogram is displayed on a live preview screen that includes a main window for displaying a live preview of said image data, said live preview screen also including a histogram window for simultaneously displaying said histogram, said histogram window being implemented as an overlay of said main window.

15. The system of claim 3 wherein said histogram is displayed on a live preview screen that includes a main window for displaying a live preview of said image data, said live preview screen also including a histogram window for simultaneously displaying said histogram, said histogram window being implemented as a semi-transparent version of said histogram that is superimposed over said image data in said main window.

16. The system of claim 3 wherein a device user initially selects either a manual live preview mode or an automatic live preview mode for said electronic device, said device user also selecting an initial exposure setting for said capture subsystem, said display controller utilizing a histogram generator to analyze said image data for generating said histogram, said display controller then simultaneously displaying said histogram and said image data on a display of said electronic device during said live preview mode.

17. The system of claim 16 wherein said device user selects said manual preview mode, said device user then analyzing said histogram and manually adjusting said exposure setting until said luminosity characteristics represented by said histogram are optimized.

18. The system of claim 16 wherein said device user selects said automatic preview mode, said display controller then utilizing a histogram analyzer to automatically analyze said histogram to generate a histogram analysis according to one or more pre-determined analysis criteria.

19. The system of claim 18 wherein said display controller adjusts said exposure setting in response to said histogram analysis so that said luminosity characteristics represented by said histogram are optimized.

20. The system of claim 16 wherein said luminosity characteristics of said image data are determined to be optimal, said electronic device then storing said final captured image in an image memory, said display controller also displaying said final captured image and a corresponding final histogram on said display of said electronic device.

21. A method for capturing electronic information with an electronic device, comprising the steps of:
generating image data with a capture subsystem, said image data having image characteristics that vary depending upon one or more capture settings;
creating a live preview representation of said image characteristics by utilizing a display controller that adjusts said one or more capture settings after said representation is analyzed during a live preview mode; and
utilizing said capture subsystem to store said image data as a final captured image after said one or more capture settings have been adjusted during said live preview mode.

22. The method of claim 21 wherein said one or more capture settings include an exposure setting for controlling luminosity characteristics of said image data provided by said capture subsystem.

23. The method of claim 22 wherein said live preview representation includes a histogram of luminosity characteristics of said image data, said histogram displaying luminosity levels for pixels of said image data ranging from one or more darkest pixels to one or more brightest pixels.

24. The method of claim 23 wherein a device user utilizes a user interface for manually adjusting said exposure setting after analyzing said histogram to thereby optimize said luminosity characteristics of said final captured image.

25. The method of claim 23 wherein a histogram analyzer of said display controller automatically adjusts said exposure setting after analyzing said histogram to thereby optimize said luminosity characteristics of said final captured image according to one or more pre-defined criteria.

26. The method of claim 22 wherein said capture subsystem includes an image sensor for initially generating said image data, an image signal processor for processing said image data, and an exposure control module that provides said exposure setting to said image sensor to vary said luminosity characteristics of said image data.

27. The method of claim 23 wherein said display controller includes controller logic that provides said image data and said histogram to a display of said electronic device, said display controller also including a histogram generator for analyzing said image data to generate said histogram, said display controller further including an exposure compensator for generating an exposure compensation signal that is provided to said capture subsystem.

28. The method of claim 27 wherein said display controller supports a manual live preview mode during which a device user manually controls said exposure compensator after analyzing said histogram on said display.

29. The method of claim 27 said display controller supports an automatic live preview mode during which a histogram analyzer automatically controls said exposure compensator after analyzing said histogram according to one or more pre-defined analysis criteria.

30. The method of claim 21 wherein a device user selects a manual live preview mode for said electronic device by programming a manual preview mode enable register, said device user alternately selecting an automatic live preview mode for said electronic device by programming an automatic preview mode enable register.

31. The method of claim 23 wherein said histogram includes a vertical axis corresponding to pixel quantities of said pixels from said image data, said histogram also including a horizontal axis that corresponds to said luminosity characteristics of said pixels, said horizontal axis having a minimum luminosity value and a maximum luminosity value.

32. The method of claim 31 wherein said display controller is capable of adjusting an upper position of said one or more brightest pixels with reference to said maximum luminosity value, said display controller also being capable of separately adjusting a lower position of said one or more darkest pixels with reference to said minimum luminosity value.

33. The method of claim 31 wherein said display controller utilizes a highlight-biased exposure technique to maximize a signal-to-noise ratio of said final captured image, said display controller adjusting said exposure setting of said capture subsystem to position said histogram as close as possible to said maximum luminosity value without clipping said one or more brightest pixels.

34. The method of claim 23 wherein said histogram is displayed on a live preview screen that includes a main window for displaying a live preview of said image data, said live preview screen also including a histogram window for simultaneously displaying said histogram, said histogram window being implemented as an overlay of said main window.

35. The method of claim 23 wherein said histogram is displayed on a live preview screen that includes a main window for displaying a live preview of said image data, said live preview screen also including a histogram window for simultaneously displaying said histogram, said histogram window being implemented as a semi-transparent version of said histogram that is superimposed over said image data in said main window.

36. The method of claim 23 wherein a device user initially selects either a manual live preview mode or an automatic live preview mode for said electronic device, said device user also selecting an initial exposure setting for said capture subsystem, said display controller utilizing a histogram generator to analyze said image data for generating said histogram, said display controller then simultaneously displaying said histogram and said image data on a display of said electronic device during said live preview mode.

37. The method of claim 36 wherein said device user selects said manual preview mode, said device user then analyzing said histogram and manually adjusting said exposure setting until said luminosity characteristics represented by said histogram are optimized.

38. The method of claim 36 wherein said device user selects said automatic preview mode, said display controller then utilizing a histogram analyzer to automatically analyze said histogram to generate a histogram analysis according to one or more pre-determined analysis criteria.

39. The method of claim 38 wherein said display controller adjusts said exposure setting in response to said histogram analysis so that said luminosity characteristics represented by said histogram are optimized.

40. The method of claim 36 wherein said luminosity characteristics of said image data are determined to be optimal, said electronic device then storing said final captured image in an image memory, said display controller also displaying said final captured image and a corresponding final histogram on said display of said electronic device.

41. A system for capturing electronic information with an electronic device, comprising:
means for generating image data that has image characteristics that vary depending upon one or more capture settings;
means for creating a live preview representation of said image characteristics;
means for adjusting said one or more capture settings after said representation is analyzed during a live preview mode; and
means for storing said image data as a final captured image after said one or more capture settings have been adjusted during said live preview mode.

42. A system for capturing electronic information with an electronic device, comprising:
a capture subsystem configured to generate image data that has image characteristics that vary depending upon one or more capture settings; and
a display controller coupled to said capture subsystem for creating a live preview representation of said image characteristics, said display controller adjusting said one or more capture settings after said representation is analyzed during a live preview mode.
